(19) United States
(12) Patent Application Publication
(10) Pub. No.: US 2012/0081643 A1
(43) Pub. Date: Apr. 5, 2012

(54) DISPLAY DEVICE

(75) Inventors: Tomio YAGUCHI, Sagamihara (JP); Tetsuya NAGATA, Mobara (JP)

(73) Assignees: Panasonic Liquid Crystal Display Co., Ltd.; Hitachi Displays, Ltd.

(21) Appl. No.: 13/251,365

(22) Filed: Oct. 3, 2011

(30) Foreign Application Priority Data
Oct. 5, 2010 (JP) 2010-225624

(51) Int. Cl. G02F 1/1335

(52) U.S. Cl. 349/106

(57) ABSTRACT

To reduce misalignment between pixels and color filters caused by thermal expansion of substrates in a liquid crystal display device in which an opposing substrate including a resin and including color filters is disposed over a TFT substrate including a glass substrate. Glass fibers are included extendedly in the direction of a black arrow in the opposing substrate. Consequently, the thermal expansion coefficient of the opposing substrate in the direction of the black arrow is close to the thermal expansion coefficient of glass fibers and hence the difference in thermal expansion in the direction of the black arrow between the TFT substrate and the opposing substrate is small. Meanwhile, although the thermal expansion of the opposing substrate in the direction perpendicular to the black arrow is large, color purity is not influenced even if misalignment occurs in the direction.

### CLAIM OF PRIORITY

The present application claims priority from Japanese Patent Application JP 2010-225624 filed on Oct. 5, 2010, the content of which is hereby incorporated by reference into this application.

### FIELD OF THE INVENTION

The present invention relates to a display device, in particular to a flexible liquid crystal display device, an organic EL display device and an electrophoretic display device each of which has a flexible color filter substrate, and a three-dimensional display having a barrier substrate.

### BACKGROUND OF THE INVENTION

A liquid crystal display device is widely used for various applications since it is flat and lightweight. A liquid crystal display device is configured so as to interpose a crystal liquid between a TFT substrate in which pixel electrodes, TFTs (thin-film transistors), etc. are formed and an opposing substrate in which color filters, etc. are formed. Research for forming a flexible liquid crystal display device by making a TFT substrate and an opposing substrate flexible is underway.

As a technology for forming such a flexible substrate, in JP-A No. 2007-119630, a technology for forming a mechanically-strong and optically-uniform resin substrate by filling a space in a glass woven fabric composed of weft yarn and warp yarn with a thermosetting resin is described.

In JP-A No. 2004-280071, a technology is described that avoids light leakage and enhances contrast by disposing the fiber of a substrate and the transmission axis of a polarizing plate so as to either be in an identical direction or form a right angle in the substrate formed by filling a space in a glass woven fabric composed of weft yarn and warp yarn with a thermosetting resin.

In JP-A No. 2001-133761, a substrate formed by not weaving fiber such as glass fiber into a woven fabric but disposing the fiber in one direction and filling a space among fiber with a resin is described. Then it is also described that a TFT substrate is formed by stacking a plurality of such substrates so that the fibers of the substrates may be perpendicular to each other.

In a flexible liquid crystal display device or the like, since a TFT uses a high temperature process, a glass substrate is formed, thereafter the glass is thinned by polishing, and thus a flexible substrate is obtained. In contrast, a color filter does not require a high temperature process and hence a resin substrate can be used. When a TFT substrate is formed with a glass substrate and an opposing substrate in which color filters and the like are formed is formed with a flexible plastic substrate, an arising problem is that a color filter formed in the opposing substrate and a pixel electrode formed in the TFT substrate come to be misaligned by difference in thermal expansion between the TFT substrate and the opposing substrate.

Meanwhile, in an organic EL display device, color filters are disposed sometimes in order to further improve color purity. In a case like this, operability and yield become problems in the adhesion of a color filter substrate. Further, in an electrophoretic display device using black electrophoretic particles and white electrophoretic particles, color display is possible by adhering a color filter substrate but in this case, too operability and yield become problems in the operation of adhering the color filter substrate to the electrophoretic display device formed of glass.

In parallax barrier type three-dimensional display, three-dimensional display can be materialized by adhering a barrier substrate in which a barrier pattern is formed to a two-dimensional display device and thereby making use of parallax between the right eye and the left eye. In this case too, operability and yield become problems in the adherence of the barrier substrate to the two-dimensional display device.

When a color filter substrate is formed with a resin, the difference in thermal expansion between a display device and the color filter substrate becomes a problem in improving operability and yield in the case of the combination of the color filter substrate and either an organic EL display device or an electrophoretic display device. Further, when a barrier substrate is formed with a resin in a three-dimensional display device, the difference in thermal expansion between a two-dimensional display device and the barrier substrate becomes a problem.

Such problems are not described in any of JP-A Nos. 2007-119630, 2004-280071 and 2001-133761. An object of the present invention is, when an opposing substrate is formed with a resin in a flexible liquid crystal display device, to solve the problem of difference in thermal expansion between a glass substrate and a color filter substrate in the case of adhering the color filter substrate formed of resin in an organic EL display device or an electrophoretic display device or in the case of adhering a barrier substrate formed with a resin in a three-dimensional display device.

### SUMMARY OF THE INVENTION

The present invention solves the above problems and the main means thereof are as follows.

(1) A liquid crystal display device provided with a TFT substrate in which pixels having pixel electrodes and TFTs are formed and an opposing substrate in which color filters are formed in a manner of interposing a liquid crystal between the TFT substrate and the opposing substrate, wherein the opposing substrate is a resin substrate in which glass fibers or carbon fibers extend in a first direction and are aligned in a second direction perpendicular to the first direction and the color filters are formed into a stripe shape extendedly in the second direction; and, in the TFT substrate, a plurality of pixels to display image data of an identical color are formed in a direction where the color filters extend.

(2) An organic EL display device configured by sealing an element substrate in which light emitting elements are formed with a sealing substrate and adhering a color filter substrate to the element substrate or the sealing substrate, wherein the color filter substrate is a resin substrate in which glass fibers or carbon fibers extend in a first direction and are aligned in a second direction perpendicular to the first direction and color filters are formed into a stripe shape extendedly in the second direction; and, in the element substrate, a plurality of pixels to emit light of an identical color are formed in a direction where the color filter extends.

(3) An electrophoretic display device configured by forming pixels, each of which has an insulating liquid and electrophoretic particles in a region surrounded by a front substrate, a back substrate, and partition walls, into a matrix shape, and adhering a color filter substrate to the front substrate, wherein the color filter substrate is a resin substrate in which glass fibers or carbon fibers extend in a first direction and are aligned in a second direction perpendicular to the first direction and color filters are formed into a stripe shape extendedly in the second direction; and a plurality of pixels to display an identical color in the pixels are formed in a direction where the color filters extend.

(4) A three-dimensional display device configured by adhering a parallax barrier substrate to a flat image display device, wherein the parallax barrier substrate is a resin substrate in which glass fibers or carbon fibers extend in a first direction and are aligned in a second direction perpendicular to the first direction and barrier patterns are formed into a stripe shape extendedly in the second direction.

The present invention, in a flexible liquid crystal display device including a TFT substrate having TFTs and pixel electrodes and being formed with a substrate including glass and an opposing substrate being formed with a flexible resin plate and having color filters, makes it possible to reduce positional misalignment between the color filters and the pixel electrodes caused by a difference in thermal expansion between the opposing substrate and the TFT substrate.

Further, the present invention, in an organic EL display device or an electrophoretic display device, makes it possible to prevent misalignment between a pixel and a color filter caused by difference in thermal expansion between a substrate and a color filter substrate in the display device in the case of disposing the color filter substrate formed of resin. Furthermore, the present invention, in a parallax barrier type three-dimensional display device, makes it possible to prevent misalignment between a barrier pattern in a barrier substrate and a pixel in a flat image display device caused by a difference in thermal expansion, and hence form a stable three-dimensional image.

### BRIEF DESCRIPTION OF THE DRAWINGS

FIG. 1 is an exploded perspective view of a liquid crystal display device according to the present invention;

FIG. 2 is a sectional view of a liquid crystal display device according to the present invention;

FIG. 3 is a structural drawing of a flexible resin substrate used in the present invention;

FIG. 4 is a plan view showing the direction where glass fibers extend in an opposing substrate;

FIG. 5 is a layout drawing of color filters in an opposing substrate;

FIG. 6 is an enlarged view of color filters in an opposing substrate;

FIG. 7 is an enlarged view of color filters in an opposing substrate in a conventional example;

FIG. 8 is a schematic plan view of a TFT substrate according to the present invention;

FIG. 9 is a schematic plan view of a TFT substrate in the case of applying the present invention to a liquid crystal display device of a longitudinal electric field drive type;

FIG. 10 is a schematic plan view of a TFT substrate in the case of applying the present invention to a liquid crystal display device of a transverse electric field drive type;

FIG. 11 is a schematic view showing the principle of a parallax barrier type three-dimensional image display method;

FIG. 12 is an exploded perspective view of a parallax barrier type three-dimensional display device to which the present invention is applied;

FIG. 13 is an assembly diagram of a parallax barrier type three-dimensional display device in the case of using a glass-made barrier substrate;

FIG. 14 is an assembly diagram of a parallax barrier type three-dimensional display device in the case of using a barrier substrate according to the present invention;

FIG. 15 is a sectional view in the case of applying the present invention to an organic EL display device; and

FIG. 16 is a sectional view in the case of applying the present invention to an electrophoretic display device.

### DETAILED DESCRIPTION OF THE PREFERRED EMBODIMENTS

The contents of the present invention are hereunder explained in detail with examples.

### EXAMPLE 1

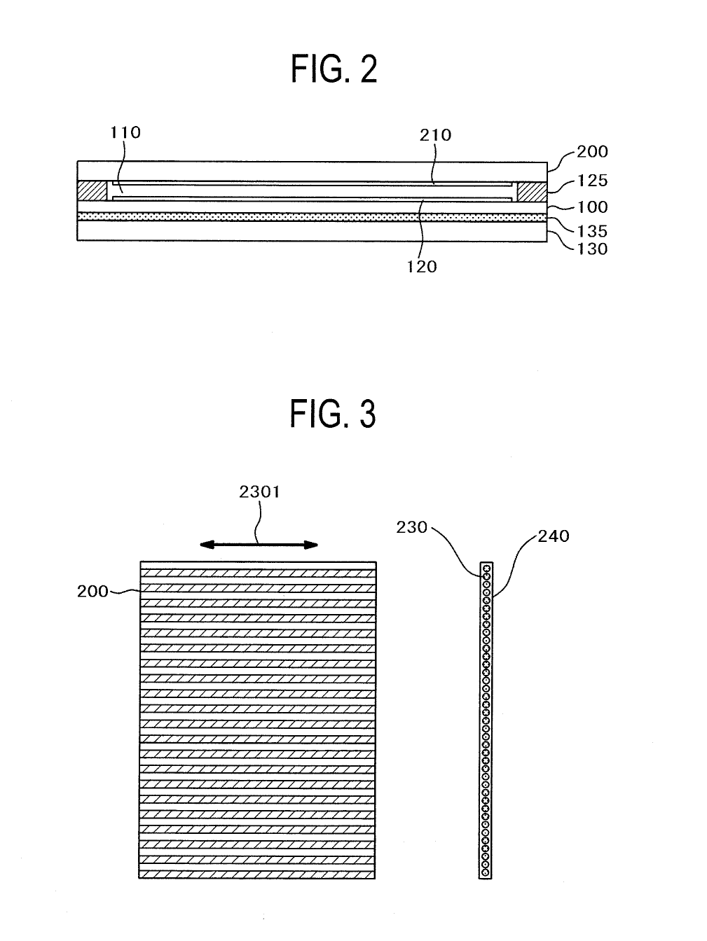

FIG. 2 is a sectional view of a flexible liquid crystal display device according to the present invention. In FIG. 2, a liquid crystal 110 is encapsulated in a region surrounded by a TFT substrate 100, an opposing substrate 200, and seal materials 125. TFTs, pixel electrodes, etc. are formed in the TFT substrate 100 and the TFT substrate comprises glass because a high temperature process is required for forming the TFTs.

Although the thickness of a TFT substrate 100 comprising glass is about 0.4 mm in the beginning, after TFTs are formed, the glass substrate is thinned to about 0.05 mm by polishing. A grass substrate becomes flexible when the thickness is reduced to that extent. Since the strength of a TFT substrate 100 is insufficient as it is, however, a resin plate 130 is adhered to the glass substrate through an adhesive 135. The resin plate 130 is flexible and hence the TFT substrate 100 is also a flexible substrate as a whole.

In contrast, the opposing substrate 200 does not require such a high temperature process as required of TFTs and hence a flexible resin substrate is used. Since both the TFT substrate 100 and the opposing substrate 200 are flexible, a flexible display device can be formed. In the case of such a configuration, however, since the TFT substrate 100 in which TFTs, pixel electrodes, etc. are formed is made of glass and the opposing substrate 200 in which color filters 210, etc. are formed is made of resin, the thermal expansion coefficients are different from each other and an arising problem is that pixels 120 formed in the TFT substrate 100 and the color filters 210 formed in the opposing substrate 200 are misaligned by the thermal cycles of the TFT substrate 100 and the opposing substrate 200 after adhesion.

In order to solve the problem, an opposing substrate 200 shown in FIG. 3 is used in the present invention. In FIG. 3, the figure on the left side represents a plan view and the figure on the right side represents a side view. In the opposing substrate 200 of FIG. 3, glass fibers 230 are disposed in a resin, the glass fibers 230 extend in one direction, namely in the direction of the black arrow 2301, and are aligned in a direction perpendicular to the direction. In an opposing substrate 200 of such a configuration, the thermal expansions of the opposing substrate 200 in the extending direction and in the direction perpendicular to the extending direction of the glass fibers 230 are different from each other. The thermal expansion coefficient of the glass fibers 230 is 3.8×10⁻⁶/° C. and is about 1/20 of the expansion coefficient of the used resin that is about 70-80×10⁻⁶/° C.

Meanwhile, as a fiber, a carbon fiber can be used besides a glass fiber 230. As a carbon fiber, a carbon nanofiber or a carbon nanotube can be used. In any of the cases of a glass fiber 230 and a carbon fiber, a refraction coefficient close to that of a resin material 240 is desirable. Further, it is desirable that the diameter of a fiber is not more than 500 nm so as not to interfere with visible light transmission. As the resin material 240, a resin of an acrylic type or an epoxy type can be used. Either a glass fiber 230 or a carbon fiber can be used as a fiber in the opposing substrate 200 as stated above, but explanations are made hereunder on the basis of a glass fiber 230.

In FIG. 3, since the glass fibers 230 extend in the transverse direction in lines, the thermal expansion coefficient in the transverse direction is small and close to the thermal expansion coefficient of glass. In contrast, the thermal expansion coefficient in the longitudinal direction, namely in the direction perpendicular to the direction where the glass fibers 230 extend, is close to the thermal expansion coefficient of a resin and hence is largely different from the thermal expansion coefficient of glass constituting a TFT substrate 100. Here, although the glass fibers 230 are aligned completely parallel in the transverse direction in FIG. 3, they are not necessarily required to be aligned completely parallel and the glass fibers 230 may partially intersect with each other. That is, it is acceptable as long as they are aligned nearly in the transverse direction. In other words, the effects of the present invention can be exhibited as a whole as long as the thermal expansion coefficient in the extending direction of the glass fibers 230 is smaller than the thermal expansion coefficient in the direction perpendicular to the extending direction.

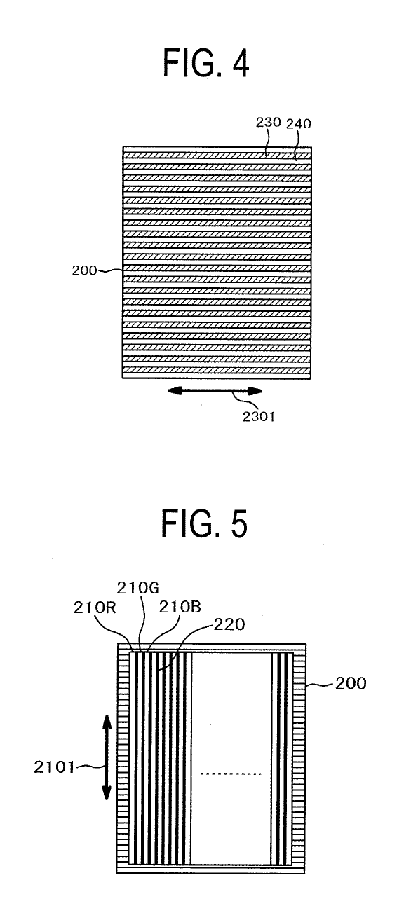

FIGS. 4 and 5 are views showing the relationship between the direction where glass fibers 230 extend in an opposing substrate 200 and the direction where color filters 210 formed in the opposing substrate 200 extend. In FIG. 4, the black arrow 2301 in the transverse direction shows the direction where the glass fibers 230 extend. The configuration of the glass fibers 230 is the same as that explained in FIG. 3. FIG. 5 is a plan view showing the state where color filters 210 and black matrices 220 are formed in the opposing substrate 200 shown in FIG. 4. In FIG. 5, the black arrow 2101 in the longitudinal direction shows the direction where the color filters 210 extend. The color filters 210 extend in a stripe shape in the longitudinal direction. The direction where the color filters 210 extend shown in FIG. 5 and the direction where the glass fibers 230 extend shown in FIG. 4 are at right angles to each other.

In FIG. 5, a red color filter 210R, a green color filter 210G, and a blue color filter 210B extend in the longitudinal direction and are aligned in the transverse direction. A black matrix 220 is disposed between adjacent two color filters 210. A black matrix is formed also on the periphery of a screen. In FIG. 5, however, black matrices to partition pixels 120 are not formed in the stripe-shaped color filters 210. As will be explained later, a liquid crystal display device according to the present invention is configured so as not to affect color purity even when an opposing substrate 200 and a TFT substrate 100 are misaligned from each other in the direction of the stripes of the color filters 210 by thermal expansion and the like.

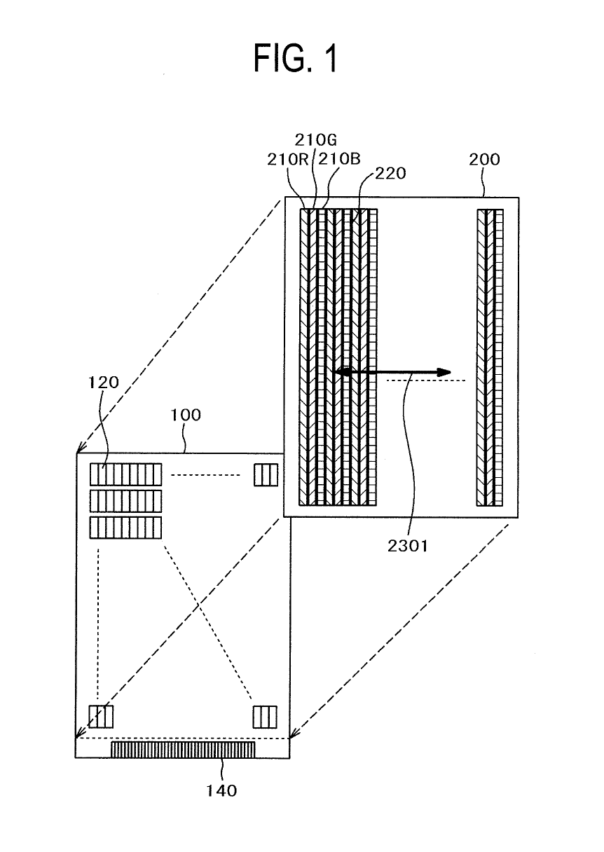

FIG. 1 is a view showing the relationship between a TFT substrate 100 and an opposing substrate 200 according to the present invention. In FIG. 1, a liquid crystal, although not shown in the figure, is interposed between the TFT substrate 100 and an opposing substrate 200. The TFT substrate 100 in FIG. 1 includes a display region where pixels 120 are formed in a matrix shape and a terminal section 140. Each of the pixels 120 conceptually includes a pixel electrode 101 and a TFT. The pixels 120 are formed over a glass substrate as explained in FIG. 2 and the glass substrate adheres to a resin substrate through an adhesive 135. However, the thermal expansion coefficient of the TFT substrate 100 at a part where the pixels 120 are formed is close to that of the glass.

In the opposing substrate 200 shown in FIG. 1, color filters 210 are formed into a stripe shape. Black matrices 220 are formed between adjacent two color filters of red color filters 210R, green color filters 210G, and blue color filters 210B. In FIG. 1, in the opposing substrate 200, glass fibers 230 extend in the direction of the black arrow 2301 and are aligned in the direction perpendicular to the extending direction. Consequently, the thermal expansion coefficient of the opposing substrate 200 in the transverse direction, namely in the direction of the black arrow 2301, takes a value close to the glass fibers 230. In contrast, the thermal expansion coefficient in the direction perpendicular to the extending direction, namely in the longitudinal direction, is comparable to that of a resin.

In such a configuration, when the temperature of a liquid crystal display device changes, the relationship of thermal expansion between a TFT substrate 100 and an opposing substrate 200 is different between in the transverse direction and in the longitudinal direction. That is, the difference in thermal expansion between a TFT substrate 100 and an opposing substrate 200 is small in the direction of the black arrow 2301, namely in the direction where the glass fibers 230 extend in the opposing substrate 200. In other words, the misalignment between the color filters 210 in the opposing substrate 200 and the pixel electrodes 101 in the TFT substrate 100 is small. Although different colors are allocated in the transverse direction of the opposing substrate 200, the misalignment between the TFT substrate 100 and the opposing substrate 200 is small and hence color purity does not deteriorate.

On the other hand, in the direction perpendicular to the black arrow 2301, namely in the longitudinal direction in FIG. 1, the misalignment caused by thermal expansion between the TFT substrate 100 and the opposing substrate 200 is large. In FIG. 1, however, pixels 120 of an identical color are formed in the longitudinal direction and hence color purity does not deteriorate even if misalignment occurs in the longitudinal direction. Further, as shown in FIG. 1, no black matrices to partition pixels in the longitudinal direction are formed in the stripe shaped color filters 210.

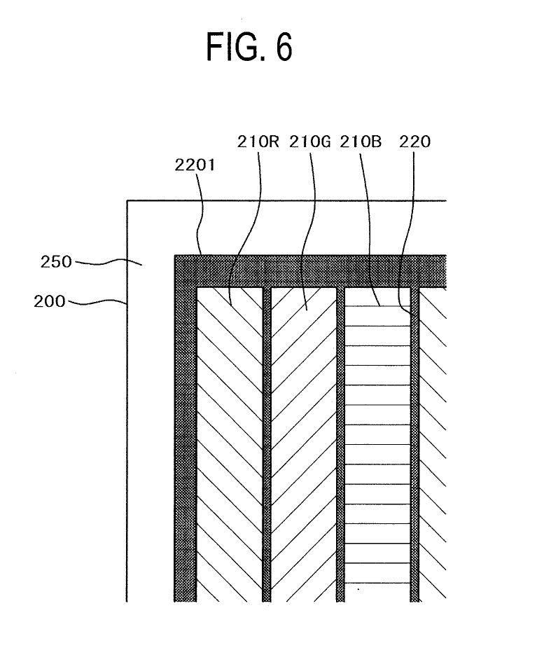

FIG. 6 is a partially enlarged view of the opposing substrate 200 according to the present invention shown in FIG. 1. In FIG. 6, a red color filter 210R, a green color filter 210G, and a blue color filter 210B are formed into a stripe shape. Black matrices 220 are formed between the color filters 210 in a stripe shape extendedly in the longitudinal direction. Further, a peripheral black matrix 2201 is formed on the periphery of the color filters 210R, 210G, and 210B. However, no black matrices to partition pixels 120 in the longitudinal direction are formed.

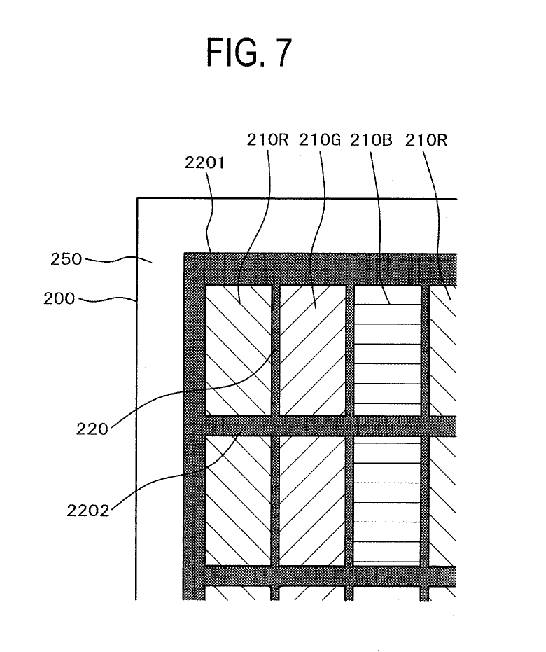

FIG. 7 is a plan view showing the relationship between color filters 210 and black matrices 220 in a conventional opposing substrate 200. In FIG. 7, black matrices 2202 extending in the transverse direction are formed in order to partition pixels in the longitudinal direction too. In this case, when a TFT substrate 100 and the opposing substrate 200 are misaligned from each other in the longitudinal direction, the transmissivity of a liquid crystal display device deteriorates because of the black matrices 2202 extending in the transverse direction.

Here, in FIGS. 6 and 7, no black matrices are formed at the outermost periphery 250 of an opposing substrate 200. The purpose thereof is to make it possible to irradiate a seal material with ultraviolet light when the opposing substrate 200 and a TFT substrate 100 are adhered with the seal material comprising an ultraviolet curable resin.

Now back to FIG. 1, in an opposing substrate 200 according to the present invention, no black matrices 220 to partition pixels 120 in the transverse direction are formed in stripe-shaped color filters 210. Consequently, even when a TFT substrate 100 and an opposing substrate 200 are misaligned due to thermal expansion, the transmissivity of pixels 120 does not deteriorate as long as the misalignment is in the longitudinal direction. Further, even when misalignment occurs in the longitudinal direction, color purity does not deteriorate. In contrast, when misalignment in the transverse direction in FIG. 1 occurs between an opposing substrate 200 and a TFT substrate 100, both color purity and the transmissivity of pixels 120 deteriorate but the misalignment in the direction is very small because the difference in thermal expansion between the TFT substrate 100 and the opposing substrate 200 is small.

Consequently, by the configuration according to the present invention, even when misalignment occurs due to thermal expansion between an opposing substrate 200 and a TFT substrate 100, neither color purity nor the transmissivity of pixels 120 deteriorates. In the vicinity of a TFT formed in a TFT substrate 100, however, a pixel electrode 101 does not exist. Consequently, light from backlight may possibly leak from the part and in this case the contrast of an image lowers. For that reason, light from backlight has to be shielded in the vicinity where a TFT is formed.

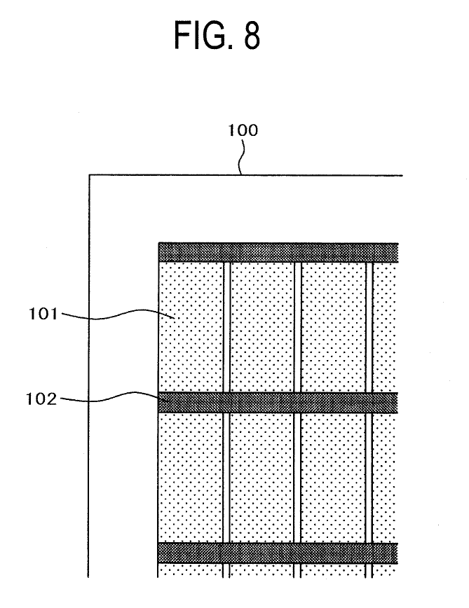

FIG. 8 is a schematic plan view of a TFT substrate 100 to shield light at the part. In FIG. 8, a pixel electrode 101 is surrounded by image signal lines extending in the longitudinal direction, not shown in the figure, and light shielding regions 102 extending in the transverse direction. Here, an image signal line is formed in a region partitioning pixel electrodes 101 in the transverse direction in FIG. 8. A TFT is formed in a light shielding region 102. By forming light shielding regions 102 as shown in FIG. 8, it is possible to prevent light from backlight from leaking and keep contrast.

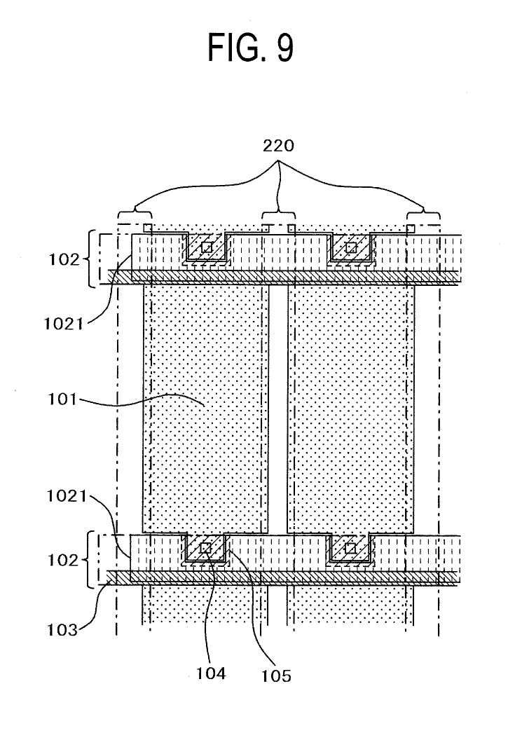

FIG. 9 is a plan view of concrete pixels 120 in the state where light shielding regions 102 are formed in a liquid crystal display device of a Twisted Nematic (TN) or Vertical Alignment (VA) system. In the TN or VA system, liquid crystal molecules are driven by a longitudinal electric field formed between a TFT substrate 100 and an opposing substrate 200 and hence such a display device is also called a longitudinal electric field system liquid crystal display device.

In FIG. 9, the parts shown with dashed-dotted lines are parts where black matrices 220 are formed in an opposing substrate 200 and hence light does not leak from the parts. In FIG. 9 further, metal-made scanning lines 103 are formed in the transverse direction and hence light does not leak from the parts.

In FIG. 9, although TFTs are omitted, through holes 104 connected to source electrodes 105 of TFTs are described. Picture signals are supplied to pixel electrodes 101 through the through holes 104. Metal-made source electrodes 105 of the TFTs are formed at the parts where the through holes 104 are formed and hence light does not leak from the parts.

In FIG. 9, light shielding transparent electrodes 1021 are formed in the manner of covering the scanning lines 103, the source electrodes 105, and others. To the light shielding transparent electrodes 1021, a different voltage from the pixel electrodes 101 is supplied. That is, to the light shielding transparent electrodes 1021, such a constant voltage as not to transmit light is supplied by the relationship with opposing electrodes formed in an opposing substrate 200. Here, the constant voltage already exists as a voltage for black display and hence it is not necessary to produce voltage specifically for the light shielding transparent electrodes 1021.

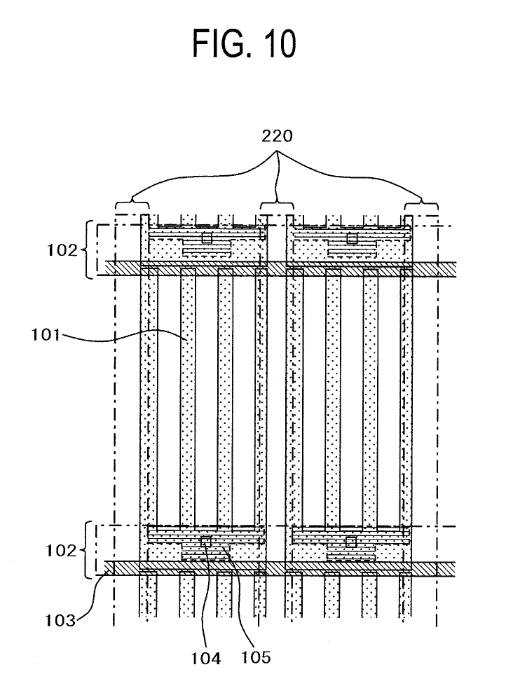

FIG. 10 is a plan view of concrete pixels 120 in the state where light shielding regions 102 are formed in a liquid crystal display device of an In Plane Switching (IPS) system. In an IPS system liquid crystal display device, liquid crystal molecules are driven by a transverse electric field parallel with a TFT substrate 100 and hence the display device is also called a transverse electric field system liquid crystal display device.

In FIG. 10, the parts shown with dashed-dotted lines are parts where black matrices 220 are formed in an opposing substrate 200 and hence light does not leak from the parts. Further, in FIG. 10, metal-made scanning lines 103 are formed in the transverse direction and hence light does not leak from the parts.

There are various systems for IPS but the system shown in FIG. 10 is a system configured so as to form pectinate pixel electrodes 101 over opposing electrodes formed in a plane shape but not shown in the figure through an insulating film not shown in the figure. In FIG. 10, when image signals are supplied to the pixel electrodes 101, by rotating liquid crystal molecules by the electric field formed between the pectinate electrodes and the opposing electrodes formed at a lower part but not shown in the figure, the transmission in a liquid crystal layer 110 is controlled and an image is formed. Here, both the pixel electrodes 101 and the opposing electrodes are transparent electrodes and include Indium Tin Oxide (ITO).

In this way, in IPS, liquid crystal molecules are controlled and light transmitting a liquid crystal layer 110 at the edge parts of pixel electrodes 101 is also controlled but light is shielded at the parts where ITO exists except the edge parts. In FIG. 10, by forming pixel electrodes 101 up to light shielding regions 102, it is possible to form the light shielding regions 102 with the liquid crystal. Consequently, in IPS, it is unnecessary to form electrodes for light shielding regions 102 separately from pixel electrodes 101.

However, at the lower part of a pixel electrode 101, namely at the upper part of a light shielding region 102 in FIG. 10, a part where an electric field is generated exists between the pixel electrode 101 and an opposing substrate and light shielding is insufficient at the part. In the region therefore, a source electrode 105 including a metal and being formed in the part of a through hole 104 is formed in an enlarged manner and is used as a light shielding film. In this way, in IPS shown in FIG. 10, only by forming pixel electrodes 101 extendedly in the longitudinal direction and changing the shape of source electrodes 105, it is possible to form light shielding regions 102.

### EXAMPLE 2

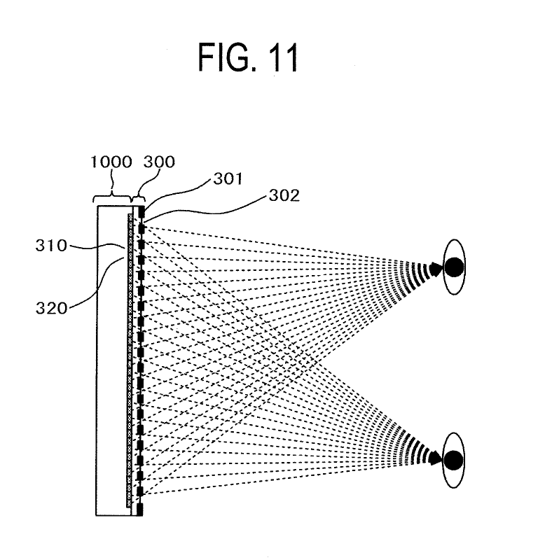

Example 2 is a case of applying the present invention to a three-dimensional display device. There exist various kinds of three-dimensional display devices and a parallax barrier method shown in FIG. 11 is known as a method for displaying a three-dimensional image without the use of a pair of glasses. In FIG. 11, a flat image display device 1000 is disposed behind a plate, called a parallax barrier panel, in which a plurality of fine black barriers are formed in the longitudinal direction. The parallax barrier method is a method of forming a three-dimensional image by cutting out a right eye image 320 and a left eye image 310 from an image formed in a flat image display device 1000 with barrier patterns 301. In FIG. 11, the flat image display device 1000 may be a liquid crystal display device, a plasma display device, or an organic EL display device. In a barrier panel, transmission regions 302 are formed at the spaces between barrier patterns 301.

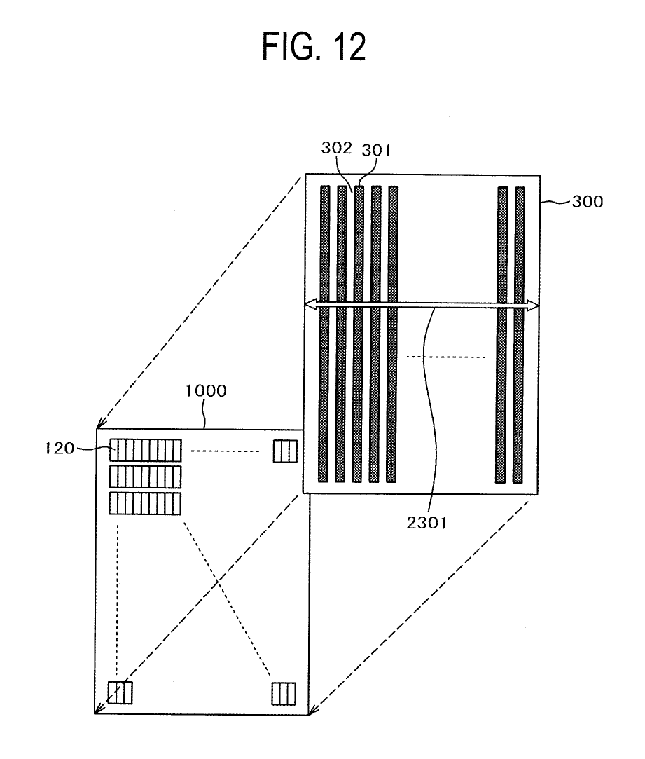

FIG. 12 is an exploded perspective view showing a flat image display device 1000 and a barrier panel. Pixels 120 are formed in a matrix shape in the flat image display device 1000. Stripe shaped barrier patterns 301 are formed in a barrier substrate 300 and the spaces between the barrier patterns 301 constitute transmission regions 302.

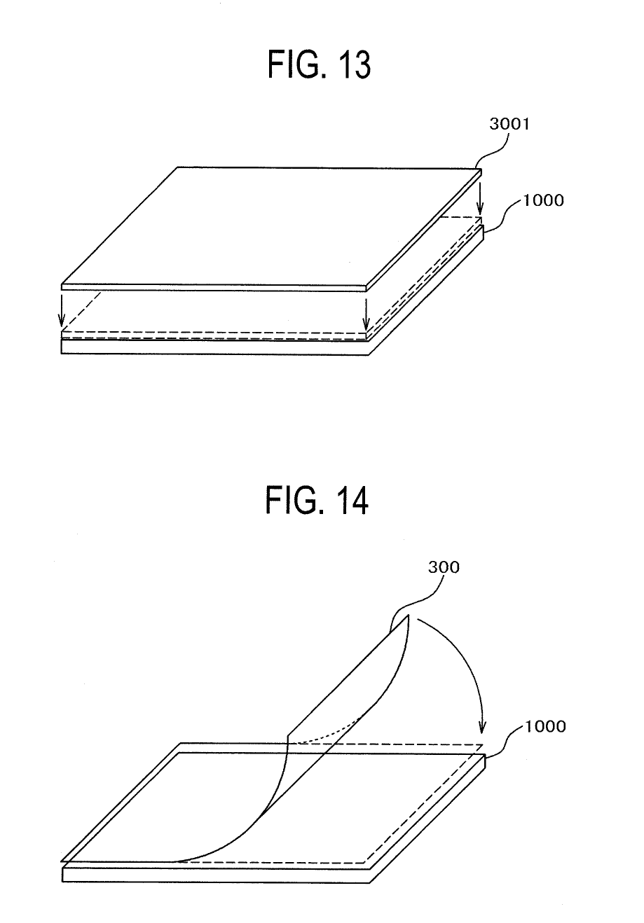

The substrate of the flat image display device 1000 is generally made of glass. The barrier substrate 300 has to be adhered to the flat image display device 1000. FIG. 13 is a view showing the state of adhering a glass-made barrier substrate 3001 to a flat image display device 1000. In this case, air bubbles are likely to be engulfed in between when the flat image display device 1000 and the barrier substrate 300 are adhered. If the barrier substrate 3001 can be formed with a flexible resin or the like, such an adhesion method as shown in FIG. 14 is possible and the risk of engulfing air bubbles between the flat image display device 1000 and the barrier substrate 300 decreases.

When a barrier substrate 300 is formed with a flexible resin substrate, an arising problem is a difference in thermal expansion from a flat image display device 1000 formed with a glass substrate. That is, in a parallax barrier method, it is necessary to precisely specify the relationship between the pitch of barrier patterns 301 in a barrier substrate 300 and the pitch of pixels 120 in a flat image display device 1000. If the relationship between the pitch of barrier patterns 301 and the pitch of pixels 120 is disturbed due to a difference in thermal expansion, it is impossible to reproduce an appropriate three-dimensional image.

That is, in a parallax barrier method, it is necessary not to change the relationship between the pitch of barrier patterns 301 and the pitch of pixels 120. In the present example, a substrate containing glass fibers 230 shown in FIG. 3 is used as a barrier substrate 300. In the substrate shown in FIG. 3, the thermal expansion coefficient in the direction where glass fibers 230 extend is close to the thermal expansion coefficient of glass, and the thermal expansion coefficient in the direction perpendicular to the extending direction of the glass fibers 230 is close to the thermal expansion coefficient of a resin. Consequently, by matching the direction of the pitch of the barrier patterns 301 with the direction where the glass fibers 230 extend in a barrier substrate 300, it is possible to inhibit the variation between the pitch of barrier patterns 301 and the pitch of the pixels 120 in a flat image display device 1000 caused by thermal expansion.

In FIG. 12 again, in the barrier substrate 300, the barrier patterns 301 extend in the longitudinal direction and the spaces between the barrier patterns 301 constitute transmission regions 302. The direction of the pitch of the barrier patterns 301, namely the direction of the white arrow 2301 in FIG. 12, is the direction where the glass fibers 230 extend in the barrier substrate 300. Consequently, the thermal expansion coefficient of the barrier substrate 300 in the direction of the white arrow 2301 is close to that of glass, and the pitch of the pixels 120 of the flat image display device 1000 and the pitch of the barrier patterns 301 do not vary largely even when temperature changes. On the other hand, the thermal expansion is large in the extending direction of the barrier patterns 301 but this does not affect the formation of a three-dimensional image.

As stated above, by applying a flexible resin plate in which glass fibers 230 extend in a prescribed direction to a barrier substrate 300, it is possible to materialize a parallax barrier type three-dimensional display device that facilitates the operation of adhering a flat image display device 1000 and the barrier substrate 300 and avoids the deterioration of a three-dimensional image caused by a difference in thermal expansion between the flat image display device 1000 and the barrier substrate 300.

### EXAMPLE 3

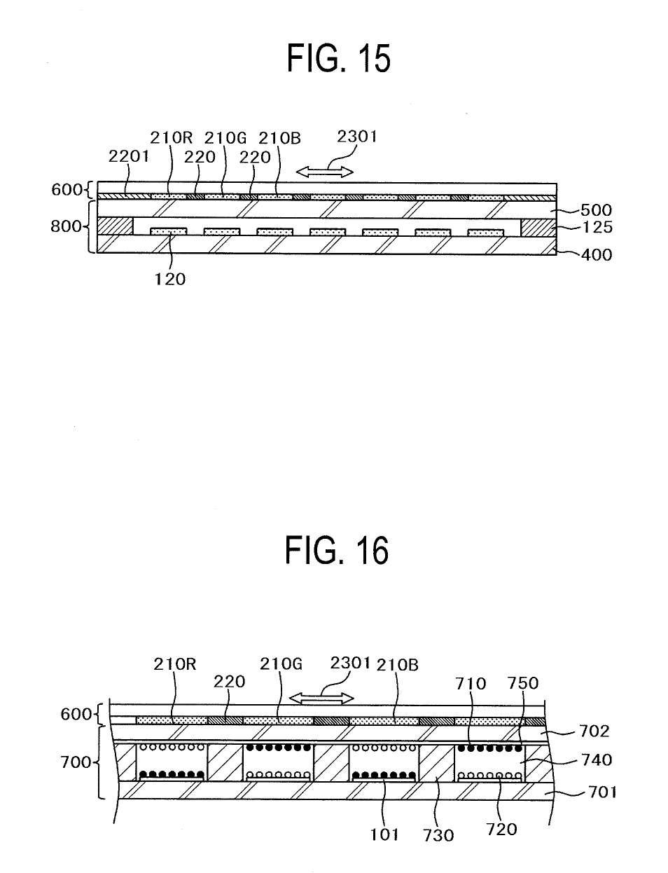

Example 1 is the case of applying a flexible substrate according to the present invention to an opposing electrode in a liquid crystal display device. A flexible substrate according to the present invention can be applied not only to a liquid crystal display device but also another display device. FIG. 15 is a case of applying a flexible substrate according to the present invention to an organic EL display device 800. In the organic EL display device 800, pixels 120 of red, green, and blue are formed in parallel into an inline stripe shape. The organic EL display device 800 is self-luminous and can emit light of three colors. In order to further purify spectra of three colors, however, color filters 210 may be used in some cases.

In FIG. 15, the color filters 210 are formed in a color filter substrate 600 and the color filter substrate 600 is adhered to a sealing substrate 500 of the organic EL display device 800. In this case, if the color filter substrate 600 is a flexible substrate like a resin substrate, adhesion operation is facilitated and yield in the adhesion operation improves. With a resin substrate, however, the thermal expansion coefficient is large and, when temperature rises, the pitch of the color filters 210 in the color filter substrate 600 and the pitch of the pixels 120 in the organic EL display device 800 differ from each other.

To cope with that, by using a substrate in which glass fibers 230 extend in a prescribed direction as shown in FIG. 3, it is possible to obtain a color filter substrate 600 having a thermal expansion coefficient in the direction where the glass fibers 230 extend close to that of glass in spite of the fact that it is a resin substrate. In FIG. 15, the white arrow 2301 shows the direction where the glass fibers 230 extend as shown in FIG. 3. Consequently, the change of the pitch of the color filters 210 in the color filter substrate 600 is small in the direction shown with the white arrow 2301 in FIG. 15.

Meanwhile, in FIG. 15, the color filters 210 in the color filter substrate 600 extend in a stripe shape in a direction perpendicular to the direction where the glass fibers 230 extend in the same way as in FIG. 3 and others. By the present invention, it is possible to materialize an organic EL display device having good color purity and facilitating the adhesion operation of the color filters 210.

FIG. 15 shows a so-called top emission type organic EL display device to emit light to the side of an element substrate 400 and the color filter substrate 600 is disposed on the side of the element substrate 400. However, the present invention can also be applied to a so-called bottom emission type organic EL display device to emit light on the other side of the element substrate 400.

### EXAMPLE 4

FIG. 16 is a sectional view showing the case of applying the present invention to an electrophoretic display device 700. In FIG. 16, a color filter substrate 600 is adhered to the electrophoretic display device 700. In the electrophoretic display device 700, an insulating liquid 740, black electrophoretic particles 710, and white electrophoretic particles 720 are encapsulated in a pixel 120 surrounded by a front substrate, a back substrate, and partition walls 730. The black electrophoretic particles 710 and the white electrophoretic particles 720 are charged differently. For example, a common electrode 750 is disposed on the upper side of a pixel 120 and a pixel electrode 101 is disposed on the lower side of the pixel 120. The black electrophoretic particles 710 or the white electrophoretic particles 720 migrate and adhere to the front substrate side of the pixel 120 by a voltage applied to the pixel electrode 101 and thereby an image is formed.

In this way, color display is possible by disposing a color filter substrate 600 in an electrophoretic display device 700. In this case too, it is desirable that the color filter substrate 600 is a flexible substrate like a resin plate 130 in order to inhibit air bubbles from being engulfed when the color filter substrate 600 is adhered. With a resin substrate, however, the thermal expansion coefficient is different from the thermal expansion coefficient of a glass substrate in the electrophoretic display device 700 and hence, when temperature rises, the pitch of color filters 210 formed in the color filter substrate 600 and the pitch of pixels 120 is mismatched. As a result, the reproducibility of an image is hindered or brightness deteriorates.

In the present example, a substrate in which glass fibers 230 extend in a prescribed direction as shown in FIG. 3 is used as a color filter substrate 600. In the color filter substrate 600, color filters 210 are formed into an inline stripe shape at a prescribed pitch and, by matching the extending direction of the glass fibers 230 with the direction of the pitch of the color filters 210, it is possible to reduce the misalignment between the pitch of the color filters 210 and the pitch of the pixels 120 in an electrophoretic display device 700 even when temperature rises.

FIG. 16 shows the state. In FIG. 16, a color filter substrate 600 is adhered to an electrophoretic display device 700 and the direction shown with the white arrow 2301 is the direction where glass fibers 230 extend in the color filter substrate 600. Consequently, the thermal expansion of the color filter substrate 600 in the direction is at the same level as the thermal expansion of the substrate of the electrophoretic display device 700. By adopting such a configuration, it is possible to produce an electrophoretic display device 700 enabling color display with a good yield.

Here, although the electrophoretic display device 700 has heretofore been explained on the basis of a type using white electrophoretic particles 720 and black electrophoretic particles 710, an electrophoretic display device 700 that displays images with only the type of the black electrophoretic particles 710 also exists. Such an electrophoretic display device 700 is structured so as to apply voltage between pixel electrodes 101 formed on a back face and a common electrode formed over the surface of partition walls 730 and display a halftone in accordance with the quantity of the black electrophoretic particles 710 existing in the pixel electrodes 101. In this case, the common electrode is not necessary in a front substrate. In the case of such an electrophoretic display device 700 too, by using a color filter substrate 600 explained above, it is possible to obtain color display.

The above explanations have been made on the basis of the case where glass fibers 230 extend in a prescribed direction in a resin substrate, but the same effects as explained above can also be obtained when carbon fibers such as carbon nanofibers or carbon nanotubes exist in place of the glass fibers 230.

What is claimed is:

1. A liquid crystal display device provided with a TFT substrate in which pixels having pixel electrodes and TFTs are formed and an opposing substrate in which color filters are formed in a manner of interposing a liquid crystal between the TFT substrate and the opposing substrate,
wherein the opposing substrate is a resin substrate in which glass fibers or carbon fibers extend in a first direction and are aligned in a second direction perpendicular to the first direction and the color filters are formed into a stripe shape extendedly in the second direction; and
in the TFT substrate, a plurality of pixels to display image data of an identical color are formed in a direction where the color filters extend.

2. The liquid crystal display device according to claim 1, wherein black matrices are formed between the color filters in the opposing substrate.

3. The liquid crystal display device according to claim 1, wherein light shielding layers including transparent electrodes are formed between the plurality of pixels aligned in the second direction in the TFT substrate.

4. A liquid crystal display device provided with a TFT substrate in which pixels having pixel electrodes and TFTs are formed and an opposing substrate in which color filters are formed in a manner of interposing a liquid crystal between the TFT substrate and the opposing substrate,
wherein the opposing substrate is a resin substrate in which glass fibers or carbon fibers extend in a first direction and are aligned in a second direction perpendicular to the first direction and color filters are formed into a stripe shape extendedly in the second direction;
in the TFT substrate, a glass substrate is adhered to a resin substrate through an adhesive and the TFTs and the pixels are formed on the side of the glass substrate; and
in the glass substrate, a plurality of pixels to display image data of an identical color are formed in a direction where the color filters extend.

5. A three-dimensional display device configured by adhering a parallax barrier substrate to a flat image display device, wherein the parallax barrier substrate is a resin substrate in which glass fibers or carbon fibers extend in a first direction and are aligned in a second direction perpendicular to the first direction and barrier patterns are formed into a stripe shape extendedly in the second direction.
